(19) United States
(12) Patent Application Publication
(10) Pub. No.: US 2019/0190270 A1
(43) Pub. Date: Jun. 20, 2019

(54) A METHOD AND SYSTEM FOR PROVIDING A RESERVE POWER FOR A POWER GRID

(71) Applicant: CATERVA GMBH, Pullach Im Isartal (DE)

(72) Inventor: Roland GERSCH, Munich (DE)

(73) Assignee: CATERVA GMBH, Pullach im Isartal (DE)

(21) Appl. No.: 16/328,104

(22) PCT Filed: Aug. 29, 2016
(86) PCT No.: PCT/EP2016/070336

§ 371 Date: Feb. 25, 2019

(51) Int. Cl. H02J 3/38; G05B 19/042

(52) U.S. Cl. CPC H02J 3/381; G05B 2219/2639; G05B 19/042

(57) ABSTRACT

A system for providing a restoration reserve power for a power grid including distributed energy resources controlled by at least one control center via control downlinks and adapted to communicate with said control center via communication uplinks, wherein at least one control center is configured to sort the energy resources by characteristics of the links and to provide the restoration reserve power to the power grid by activating sequentially the sorted energy resources starting with energy resources having links providing a short reaction time.

The invention relates to a method and a system for providing a reserve power for a power grid or electrical grid.

An electrical grid is an interconnected network for delivering electricity from power suppliers to power consumers. The electrical power grid comprises a plurality of distributed energy resources. These energy resources are provided to generate power, to store electrical power or to consume electrical power. A conventional electrical power grid comprises power generation stations that are adapted to produce electrical power. High-voltage transmission lines of the electrical power grid can carry the generated power from distant power sources to the location of demand. The transported power is provided via distribution lines to individual customers or power consumers.

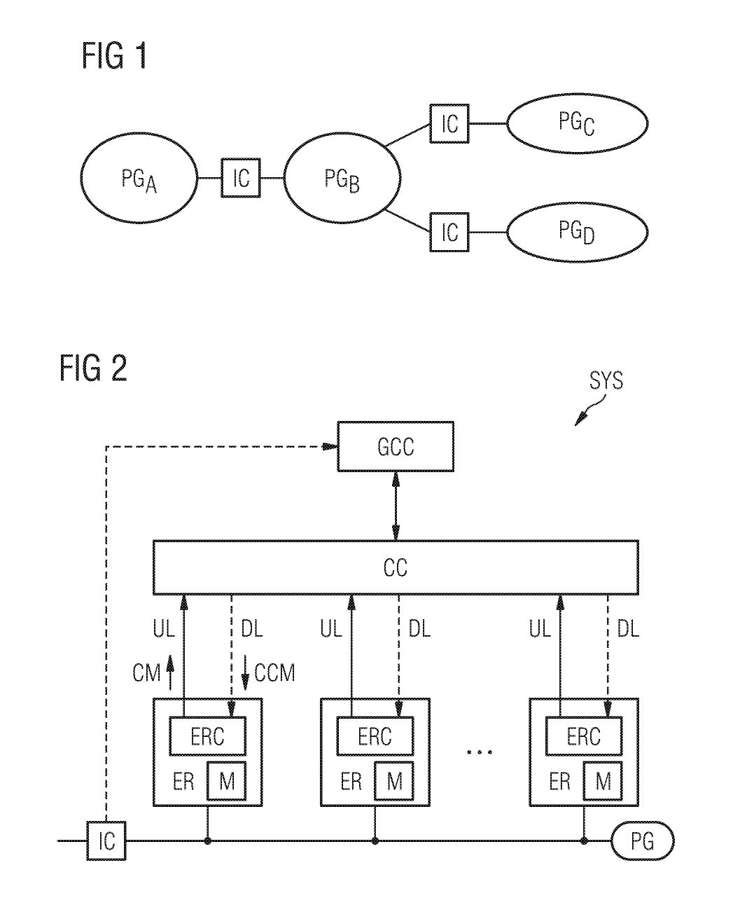

Different electrical power grids can be connected to each other to provide an interconnected grid as illustrated in FIG. 1. As shown in FIG. 1, several power grids PG are connected to each other by means of power interconnects IC. Such power interconnects IC improve reliability and stability by increasing the number of energy resources connected with each other and thereby decreasing the relative impact of the failure of a single energy resource. Such interconnections IC also allow increasing the overall efficiency because energy supply can be shifted from less efficient to more efficient energy resources. The energy supply can also be shifted to increase the share of time that the energy resources operate at peak efficiency. The energy supply can also be shifted to limit inefficient behavior of energy resources such as ramp-downs and ramp-ups. Furthermore, energy supply can be shifted to minimize transmission losses.

Traditional electrical power grids have generally been used to carry power from a few power generators to a large number of users or customers. In contrast, with the emerging power smart grid information is exchanged via a communication network to provide an automated and distributed advanced energy delivery network comprising a plurality of distributed energy resources. The energy resources can comprise distributed energy storage systems and a plurality of distributed power supply generators, in particular renewable energy sources such as generators generating energy from wind or solar power. Such a smart grid not only comprises an energy infrastructure but also a communication infrastructure. In the traditional power supply grid comprising only large centralized energy resources, a communication system can be constructed with sufficient redundancy and bandwidth between those large centralized energy resources and centralized control instances. The high complexity of the communication system in a traditional electrical power grid is justified by the significant impact every single large centralized energy resource such as a power plant has on the functionality of the power supply grid. However, with the evolving smart grid, the power supply grid becomes more and more decentralized comprising a plurality of different and distributed energy resources being linked with a wide variety of different communication downlinks and/or uplinks to local control centers of the power supply grid. In these complex smart grids, the communication infrastructure for exchanging information becomes a key factor for the operation of the power supply grid.

As illustrated in FIG. 1, different regional power supply grids are connected to each other via interconnects IC. Interconnects IC comprise metering devices adapted to monitor the electrical power transported via the respective interconnect from a first power supply grid to another power supply grid. In an interconnected power supply grid as illustrated in FIG. 1, it can happen that too much electrical power is drawn from a power supply grid via an interconnect IC by an attached neighboring power supply grid or that too much power is injected into the power supply grid from a neighboring power supply grid via the interconnect IC. An interconnector facility IC can sustain such a high power flow only for a limited time. A local power supply grid PG has therefore to balance exceedingly high power supply flows via the interconnects IC. For this purpose, the power supply grid PG has to provide a restoration power within a predetermined time period after a disturbance at an interconnection IC has been observed.

Accordingly, it is an object of the present invention to provide a method and a system for providing a restoration reserve power for a local power grid in a reliable manner to make the local power supply grid resilient against power supply disturbances at the interconnects IC.

This object is achieved according to a first aspect of the present invention by a system comprising the features of claim 1.

The invention provides according to a first aspect a system for providing a reserve power for a power grid comprising distributed energy resources controlled by at least one control center via control downlinks and adapted to communicate with said control center via communication uplinks, wherein the at least one control center is configured to sort the energy resources by characteristics of the communication links and to provide the reserve power to the power grid by activating sequentially the sorted energy resources starting with the energy resources having communication links providing a shortest reaction time.

In a possible embodiment of the system according to the first aspect of the present invention, the control center is adapted to control the energy resources by transmitting control center messages via the control downlinks connecting the control center with the distributed energy resources.

In a further possible embodiment of the system according to the first aspect of the present invention, each distributed energy resource comprises an energy resource controller adapted to transmit communication messages via the respective communication uplink to the control center.

In a further possible embodiment of the system according to the first aspect of the present invention, the control center is configured to perform a continuous monitoring of a quality of the communication links connecting the energy resources with the control center to predict a round trip time of each distributed energy resource.

In a further possible embodiment of the system according to the first aspect of the present invention, each communication message transmitted by the energy resource controller of an energy resource to the control center specifies the time of reception of the last control center message via the control downlink by the respective energy resource controller.

In a further possible embodiment of the system according to the first aspect of the present invention, the energy resource controllers of the energy resources and the control center are synchronized to each other by means of high-precision clock signals, for example according to the Network Time Protocol.

In a further possible embodiment of the system according to the first aspect of the present invention, a communication message transmitted by an energy resource controller of an energy resource via the communication uplink to the control center is adapted to transport status data and/or measurement data of the respective energy resource.

In a further possible embodiment of the system according to the first aspect of the present invention, the measurement data transported in the communication message is generated by a metering device of the respective energy resource.

In a further possible embodiment of the system according to the first aspect of the present invention, the control center is adapted to calculate a downlink communication delay across the control downlink and/or an uplink communication delay across the communication uplink on the basis of the control center messages and the communication messages exchanged between the control center and the energy resource controller of the energy resource via the control downlink and the communication uplink.

In a further possible embodiment of the system according to the first aspect of the present invention, the control center is adapted to predict a power reaction time of an energy resource depending on the calculated communication delays, a predetermined ramping delay for ramping up and/or ramping down the respective energy resource and depending on a predetermined metering delay.

In a further possible embodiment of the system according to the first aspect of the present invention, at least one control center is connected via a reliable bidirectional link to a grid control center of the power grid.

In a further possible embodiment of the system according to the first aspect of the present invention, the sorted energy resources having links with a short round trip time and/or power reaction time are kept as a restoration reserve and run at a predetermined power level until the grid control center of the power grid sends an activation control signal via the bidirectional link to the control center requesting to provide a reserve power for the power grid.

In a further possible embodiment of the system according to the first aspect of the present invention, the grid control center is connected to at least one grid interconnect of the power grid.

In a further possible embodiment of the system according to the first aspect of the present invention, a pool of energy resources including a number of energy resources comprises an associated pool control center adapted to control the energy resources of said energy resource pool via control downlinks.

In a further possible embodiment of the system according to the first aspect of the present invention, the distributed energy resources comprise energy storage systems, energy generators and/or energy consumers.

The invention further provides according to a second aspect a method for providing a reserve power comprising the features of claim 14.

The invention provides according to the second aspect a method for providing a reserve power for a power grid comprising distributed energy resources each being controlled by a control center via a control downlink and being adapted to communicate with said control center via a communication uplink, wherein the method comprises the steps of:

sorting the energy resources by characteristics of their links with the control center and

providing the reserve power for the power grid by activating sequentially the sorted energy resources starting with the energy resources having the links providing the shortest reaction time.

In a possible embodiment of the method according to the second aspect of the present invention, a quality of the links connecting the energy resources with the control center is continuously monitored to predict a round trip time of each distributed energy resource of said power grid.

In the following, possible embodiments of the different aspects of the present invention are described in more detail with reference to the enclosed figures.

FIG. 1 shows an interconnected electrical grid to illustrate a problem underlying the present invention;

FIG. 2 shows a schematic block diagram for illustrating a possible exemplary embodiment of a system for providing a restoration reserve power for a power grid according to the first aspect of the present invention;

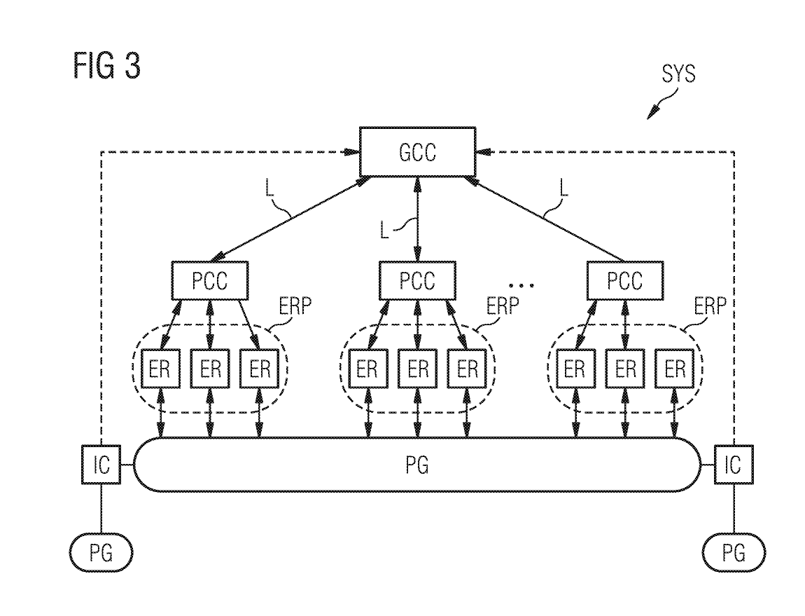

FIG. 3 shows a further schematic block diagram for illustrating a possible exemplary embodiment of a system for providing a restoration reserve power for a power grid according to the first aspect of the present invention;

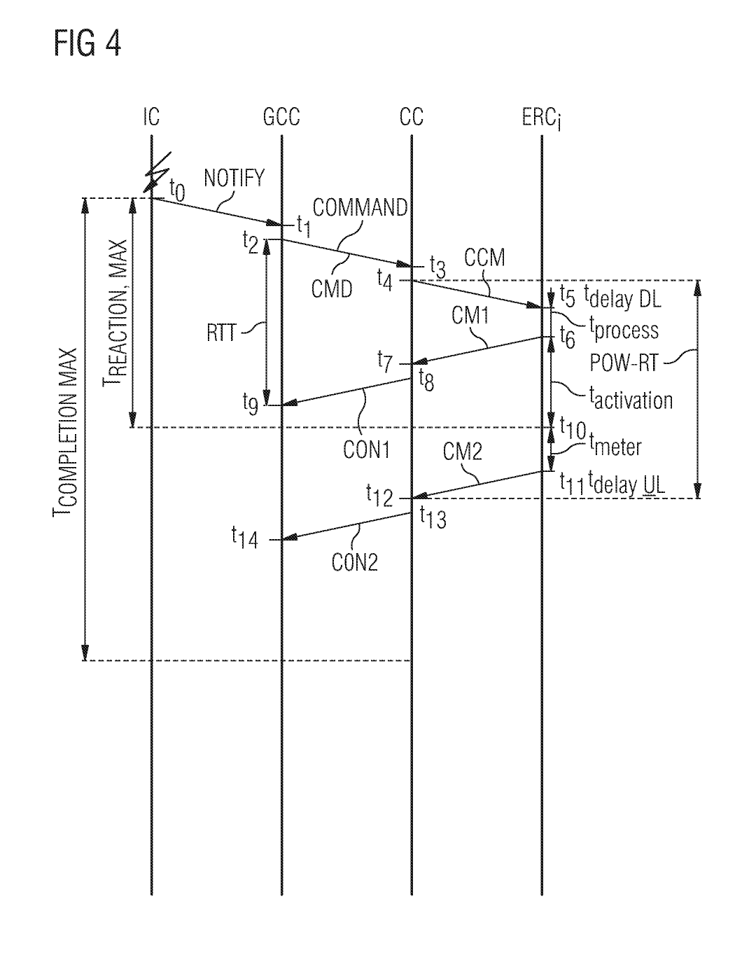

FIG. 4 shows a signaling diagram for illustrating the operation of a system for providing a restoration reserve power for a power grid in a possible implementation;

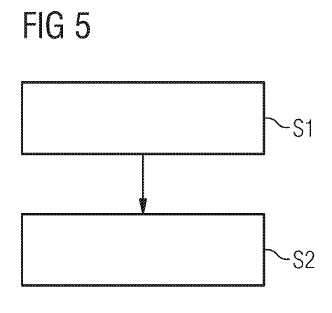

FIG. 5 shows a flowchart for illustrating a possible exemplary embodiment of a method for providing a restoration reserve power for a power grid according to the second aspect of the present invention.

As can be seen in FIG. 2, a system SYS is adapted to provide a restoration reserve power for a power grid PG. The power grid PG can comprise a plurality of distributed energy resources ER controlled by at least one control center CC. The energy resources ER can comprise different kinds and types of energy resources, in particular energy storage systems ESS, energy generators and energy-consuming devices (it is understood in the following that such energy generators generate electrical energy from a different form of energy, and likewise for the energy-consuming devices). The energy storage systems ESS can comprise supercapacitors, chargeable batteries or flywheels adapted to store electrical energy. The energy generators are provided to generate electrical power and to supply this generated electrical power to the power grid PG. The energy consumers can consume electrical power received from the power supply grid PG. Some distributed energy resources can also comprise a mix of energy-generating units, energy-consuming units and energy-storing units. Each energy resource ER is adapted to communicate with at least one control center CC of the system SYS. In a possible embodiment, the communication between the control center CC and an energy resource ER is performed via a control downlink DL and a communication uplink UL as illustrated in FIG. 2. The control center CC is adapted to control the energy resource ER by sending control center messages CCM via at least one downlink DL to the energy resource. On the other hand, the energy re-source ER can communicate with the control center CC via at least one communication uplink UL by transmitting communication messages CM via the respective communication uplink UL to the control center CC. In a possible embodiment, the energy resources ER comprise energy resource controllers ERC for communicating with the control center CC of the system SYS. The control center CC is configured to sort the energy resources ER by characteristics of the links DL, UL and to provide a restoration reserve power RRP to the power grid PG by activating sequentially the sorted energy resources ERs starting with energy resources having links providing a short reaction time. The reaction time depends on the round trip time RTT provided by the downlink DL and the uplink UL of the energy resource ER. The reaction time comprises in a preferred embodiment a communication reaction time, in particular a round trip time RTT. The reaction time can comprise in a further embodiment a combination of a communication reaction time and a power activation time.

In the embodiment illustrated in FIG. 2, the control center CC is connected via a further bidirectional link L to a grid control center GCC of the power supply grid PG. In a preferred embodiment, each power supply grid PG comprises two central grid control centers GCC each connected to at least one grid interconnect IC as shown in FIG. 2. The power supply grid PG is connected via the grid interconnect IC to a neighboring power supply grid PG of the interconnected electrical grid as also illustrated in FIG. 1. The interconnection facility IC is adapted in a preferred embodiment to monitor the power flow of electrical power P to the neighboring power supply grid PG in both directions. The interconnection IC can in a possible embodiment monitor the amount of electrical power flowing from the power supply grid PG to the neighboring power supply grid or the amount of power flowing in the other direction from the neighboring supply grid to the respective power grid PG. If the measured amount of power flowing over the interconnection IC exceeds a predetermined threshold, this deviation can be reported by the interconnection IC via a communication link to the grid control center GCC of the power grid. If, for instance, the interconnection IC notifies the grid control center CC that the power flowing into the power grid PG from at least one neighboring power grid exceeds a specific power threshold, the grid control center GCC needs to balance the power surplus by providing a reserve power RP to stabilize the power grid PG, i.e. in a given scenario, either by reducing power generated by energy resources ERs of the power grid PG and/or by increasing power consumed by energy resources ERs of the power grid PG. In reaction to a notified deviation, the grid control center GCC sends commands CMDs to the at least one control center CC to provide a necessary reserve power RP for the power grid PG. When receiving such a command message the control center CC transmits control center messages CCMs via the control down-links DLs to different distributed energy resources ERs to fulfill the received command CMD. After the energy resource controller ERC of an energy resource ER has received a control center message CCM from the control center via a control downlink DL, it can return a communication message CM via the communication uplink UL to the control center CC confirming that the energy resource controller ERC has received the message from the control center CC and will perform the necessary actions to comply with the received command. In a preferred embodiment, the energy resource controller ERC can obtain information about the current, actual power generation and/or power consumption capabilities of said energy resource and can determine whether and to which degree the received command will be complied with, relaying the degree of compliance to the control center. Such information about the current, actual power generation capabilities of said energy resource can be obtained by the energy resource controller ERC either by means of an algorithm, by means of at least one sensor monitoring the energy resource or by any combination of the two. The control center CC in turn can send a confirmation message back to the grid control center GCC indicating that the requested power reserve restoration PRR has been initiated. The time period between the transmission of the command message CMD from the grid control center GCC until reception of the confirmation message by the grid control center GCC that the power reserve restoration PRR has been initiated forms a reaction time encompassing a round trip time RTT. The reaction time must be smaller in a possible embodiment than a maximum allowable reaction time of the system SYS. The maximum allowable reaction time of the system SYS can be configured in the grid control center GCC. The maximum allowable reaction time can be based on a variety of considerations, such as the reaction times of additional energy resources and the time for which IC can carry the maximum expected power deviation before taking damage.

FIG. 4 shows an example of a communication between a grid interconnection IC, a grid control center GCC, a control center CC of the power grid PG and the energy resource controller ERC of an energy resource ER connected to the power grid PG.

At a time t₀, the interconnection IC of the power grid PG detects a deviation in the power flow to the neighboring power grid. The interconnection IC transmits a notification message NOTIFY indicating the observed deviation to the grid control center GCC. The notification message NOTIFY can comprise measurement data indicating the amount of excess power flowing through the interconnection IC. The notification message NOTIFY is received at time t₁ by the grid control center GCC as shown in FIG. 4. The information data carried in the notification message NOTIFY is processed by a processing unit of the grid control center GCC and a command message CMD is transmitted by the grid control center GCC at time t₂ via a reliable link L to at least one control center CC of the power grid PG. The command message CMD instructs the control center CC to reduce or increase the power in the power grid PG depending on the observed deviation. If, for instance, an excess of power has flown from the neighboring power grid into the power grid PG via the interconnection IC, the grid control center GCC sends a command CMD instructing the control center CC to reduce power generation/increase power consumption within the power grid PG. A command message CMD is received by the control center CC at time t₃ as illustrated in FIG. 4. The control center CC is adapted to control the number of active energy resources ER connected to the control center CC. The control center CC processes the command message CMD and transmits control center messages CCMs at time t₄ to one or several energy resource controllers ERC connected to the respective control center.

The control center CC is configured to sort different energy resources ERs having energy resource controllers ERCs connected to the control center CC by characteristics of the links, i.e. the downlinks DLs and the uplinks ULs. These characteristics can comprise different parameters such as the reliability of the respective link and/or a data transmission rate of the respective link. In a possible embodiment, the reliability of a link such as a control downlink DL or a communication uplink UL can be derived from a communication history of a plurality of control center messages CCM transmitted by the control center CC via a downlink DL to the respective energy resource controller ERC to which the energy resource controller ERC has responded successfully with a communication message CM sent by the energy resource controller ERC via the uplink UL to the communication center CC. The communication history may for instance indicate that 99% of the control center messages CCM transmitted by the control center CC to the energy resource controller ERC of a specific energy resource ER has been acknowledged and/or executed by the respective energy resource controller ERC in the past. In this case, the reliability of the uplink and downlink connecting the control center CC with the respective energy resource controller ERC is 99%. Beside the reliability of the downlink DL and uplink UL, the transmission data rate and/or response time of the downlink and/or uplink form relevant characteristics which can be used by the control center CC to sort the energy resources ERs. An energy resource ER having a very reliable link to the control center CC with a high transmission rate or bit rate and/or a short response time forms an energy resource ER which is very suitable to provide a restoration reserve power RRP in an emergency where the interconnection IC notifies a deviation to the grid control center GCC. The characteristics evaluated by an evaluation unit of the control center CC can also comprise other parameters including the type of the provided link. The downlink DL as well as the uplink UL can be formed by a wired or a wireless link. For instance, a wired link can be specified as being more reliable than a wireless link. Another possible characteristic of the links evaluated by the evaluation unit of the control center CC can be the data bandwidth BW provided by the respective link. Some of the characteristics evaluated by the evaluation unit of the control center CC can be preconfigured according to the configuration of the system SYS, for instance the known types of the different links, whereas other characteristics can be measured or monitored during operation of the system SYS. In a possible embodiment, the control center CC is configured to perform a continuous monitoring of a quality of the links DLs, ULs connecting the energy resource controller ERC of the energy resource ER with the control center CC to predict a round trip time RTT of the respective energy resource ER to comply with the command message CMD of the grid control center GCC.

As illustrated in FIG. 4, the control center CC is adapted to sort the different energy resources ERs by evaluating the characteristics of the connection links DLs, ULs on the basis of preconfigured parameters and/or monitored parameters to provide the necessary restoration reserve power RRP for the power grid PG. The control center CC is adapted to activate sequentially the sorted energy resources ERs starting with those energy resources ERs having links, i.e. a downlink DL and an uplink UL, providing a short round trip time RTT to confirm a command message CMD of the grid control center GCC. In the example illustrated in FIG. 4, the energy resource controller ERCᵢ belongs to an energy resource ERᵢ being connected to the control center CC via a control downlink DL and a communication uplink UL having promising characteristics to provide a short round trip time, i.e. a response time to a received command message CMD. In the selection process between time t₃ and time t₄, the control center CC selects the energy resource controller ERCᵢ of an energy resource ERᵢ and transmits a corresponding control center message CCM to the energy resource controller ERCᵢ via the control downlink DL notifying the energy resource controller ERCᵢ that the respective energy resource ERᵢ has to be activated to provide a contribution to the provision of the restoration reserve power RRP as requested by the grid control center GCC to over-come the notified deviation. The energy resource controller ERCᵢ receives the control center message CCM at time t₅ as illustrated in FIG. 4. The energy resource controller ERC does process the received control center message CCM and sends an acknowledgement ACK in a first communication message CM1 to the control center CC at time t₆. The acknowledgement message CM1 is received by the control center CC at time t₇. The received acknowledgement message CM1 is processed by the control center CC. At time t₈, the control center CC transmits a confirmation message CON1 to the grid control center GCC confirming that the request for providing a restoration reserve power RRP indicated in the command message CMD has been received and that suitable energy resources ERs have been instructed to comply with the command. The confirmation message CON1 is received by the grid control center GCC at time t₉. In the illustrated example of FIG. 4, the round trip time RTT for the energy resource ERᵢ is a time interval between time t₁ where the command message CMD is transmitted by the grid control center GCC and time t₉ where the grid control center GCC receives the confirmation message CON1 from the control center CC. In a possible embodiment, the round trip time RTT of the energy resource must fulfill a constraint, i.e. the round trip time RTT must be smaller than a maximum admissible reaction time t_{reaction max} as illustrated in FIG. 4.

After having received the control center message CCM at time t₅ to activate the energy resource ERᵢ, the energy resource controller ERC starts to activate the energy resource ER controlled by the energy resource controller ERC at time t₆. The energy resource controller ERC of the energy resource activates the associated energy resource ER depending on the content of the received control center message CCM and the type of the associated energy resource. If, for instance, the control center message CCM instructs the energy resource controller ERC to provide a contribution for a negative restoration reserve power RRP to reduce power within the affected power grid PG and the associated energy resource ER is a power generator, the energy resource controller ERCᵢ will ramp down the power generation resource to provide a contribution to the requested negative restoration reserve power RRP. If, in contrast, the associated energy resource ER is a power-consuming resource, the energy resource controller ERCᵢ will ramp up the power consumption of the power-consuming resource to provide a contribution to the negative restoration reserve power RRP. In a further case, if the associated energy resource comprises an energy storage system ESS, the energy resource controller ERCᵢ will control the associated energy storage system ESS to store more electrical energy to make a contribution to the negative restoration reserve power RRP requested by the grid control center GCC of the power grid PG. The necessary power activation time t_{activation} necessary to activate the respective energy resource ER can vary widely depending on the different types of energy resources ER. If, for instance, the energy resource ER is a power-producing energy resource, the power activation time t_{activation} can be comparatively short, for instance for a small renewable energy resource such as a wind turbine, or comparatively long, for instance, for a complex central thermal power production plant which requires thermal balancing of key components such as steam turbines. In the illustrated example of FIG. 4, the energy resource ER is fully activated at time t₁₀. The restoration reserve power contribution of the respective energy resource ER can then be measured by a metering device M of the energy resource ER causing a further metering delay until time t₁₁. At time t₁₁, the energy resource controller ERCᵢ of the activated energy resource ERᵢ sends a further communication message CM2 back to the control center CC indicating that the associated energy resource ER has been fully activated. The communication message CM2 can comprise further measurement data indicating the amount of restoration reserve power RRP contributed by the associated activated energy resource ERᵢ. The communication message CM2 is received by the control center CC at time t₁₂. The received communication message CM2 is processed by the control center CC. The control center then sends a further confirmation message CON2 at time t₁₃ to the grid control center GCC including the information data received from the at least one energy resource control ERCᵢ in the communication message CM2. The second confirmation message CON2 is received by the grid control center GCC at time t₁₄. In a possible embodiment, the restoration reserve power RRP from the different activated energy resources has to be provided within a maximum allowable reaction time to complete the reserve power restoration t_{completion} max as illustrated in FIG. 4. In a possible embodiment, the system SYS must fulfill at least two constraints. The round trip time RTT must be smaller than the maximum allowable reaction time t_{reaction max} the necessary restoration reserve power RRP has to be provided by the energy resources ERs within a maximum completion time t_{completion max} as shown in FIG. 4. If these constraints cannot be fulfilled by the system SYS, an error handling is performed in a preferred embodiment.

In a further possible embodiment, the system SYS must activate shares sⱼ of its maximum power generation and/or consumption sumption at different completion times t_{completion,j}≤t_{completion max}. In this embodiment, the control center CC

(1) orders the energy resources ERs by evaluating the characteristics of the connection links DLs, ULs on the basis of preconfigured parameters and/or monitored parameters,

(2) forms groups gₙ of energy resources ERs such that each group is continuous with respect to the ordering of step 1 and that the groups g₁, . . . , gⱼ best approximate the power share sⱼ and

(3) sends communication messages requesting activation to the energy resource controllers in group gⱼ at the time t_{communication, j}. The time t_{communication, j} can be calculated from the the time t_{completion,j} by subtracting the longest expected response time in the group gⱼ.

In a possible alternative embodiment, the control center CC distributes excess power generation and/or consumption capabilities over the groups gₙ so that the groups with lower n compensate possibly slower activation of the groups with higher n. The control center can send additional communication messages CM to the energy resource controllers ERCs in the groups with lower n when the activation in the groups with high n completes.

In a possible embodiment, each communication message CM transmitted by the energy resource controller ERC of an energy resource ER to the control center CC specifies a time of reception of the last control center message CCM via the control downlink DL by the respective energy resource controller ERC. The energy resource controllers ERCs of the different distributed energy resources and the control center CC can be synchronized to each other by means of a high precision clock signal that comprises in a possible implementation a period time of less than 1 second. Such times are achievable even using networks with asymmetric routing by employing, for example, the Network Time Protocol (Internet RFC 1305). The communication messages CMs transmitted by the energy resource controller ERC of the energy resource ER via the communication uplink UL to the control center CC can transport in a possible implementation status data and/or measurement data of the respective energy resource ER wherein the measurement data can be generated by a metering device M of the respective energy resource ER. The control center CC comprises a processing unit adapted to calculate a downlink communication delay DL-DELAY across the control downlink DL and/or an up-link communication delay UL-DELAY across the communication uplink UL on the basis of the control center messages CCMs and the communication messages CMs exchanged between the control center CC and the energy resource controller ERC of the energy resource via the control downlink DL and the communication uplink UL. In a possible embodiment, the control center CC is adapted to predict a power reaction time POW-RT of an energy resource ER depending on the calculated communication delays, an activation delay for activating the respective energy resource ER and depending on a metering delay MET-DELAY.

In the illustrated example of FIG. 4, a delay for transmitting a control center message CCM via the downlink DL from the control center CC to the energy resource controller is time t₅-time t₄ (t_{delay DL}). The delay for sending a confirmation message CM back to the control center is for instance t₁₂-t₁₁ (t_{delay UL}). The power reaction time POW-RT of an energy resource ERᵢ is in the illustrated example a time interval between t₄ and t₁₂ including the communication delay times t_{delay DL}, t_{delay UL}, a processing time t_{process} for processing the received control center message CCM, the activation time t_{activation} needed for activating the associated energy resource ER and the metering delay tₘₑₜₑᵣ.

The control center CC is adapted to select and then sort the different connected energy resources ER according to known and/or measured or monitored characteristics of the communication links DL, UL. Energy resources ER having links with a short round trip time RTT and/or providing a short power reaction time POW-RT are kept by the control center CC as a restoration reserve which are activated in case that the grid control center GCC requests a provision of a restoration reserve power RRP to overcome a notified deviation. Suitable energy resources ERs which are selected and kept as a restoration reserve can be run in a possible embodiment at a specific predetermined power level until the grid control center GCC of the power grid PG sends an activation control signal, i.e. a command message CMD, via the reliable bidirectional link L connecting the grid control center GCC with the control center CC requesting the control center CC to provide a restoration reserve power contribution for the power grid PG. The predetermined power level at which an energy resource ER being kept as a restoration reserve is run depends on the type of the associated energy resource ER and system requirements. If the energy resource ER is an energy storage system ESS, the batteries of the energy storage system ESS can be run at a neutral charging level providing maximum available charging and discharging capacity, which is advantageous if the maximum or expected negative restoration power is equal to the maximum or expected positive restoration power.

FIG. 3 shows a further exemplary embodiment of a system SYS according to the first aspect of the present invention. In the illustrated embodiment, the system SYS comprises different pools of energy resources ERs. Each pool of energy resources ERs includes a number N of energy resources ERs having a common associated pool control center PCC adapted to control all energy resources ERs of the respective energy resource pool. An energy resource pool ERP can comprise different distributed energy resources ERs of the same or different types. An energy resource pool ERP can for instance comprise a number of energy storage systems ESS each having a plurality of batteries. The energy resource pool ERP can also comprise power production resources and/or power-consuming resources. All pool control centers PCC are connected via reliable communication links L to a central grid control center GCC of the power grid PG. FIG. 3 shows the connection of the power grid PG to neighboring power grids via interconnections IC which can notify the grid control center GCC about observed deviations in the power exchange flow to the neighboring power grids.

FIG. 5 shows a flowchart of a possible exemplary embodiment of a method for providing a restoration reserve power RRP for a power grid PG according to the second aspect of the present invention.

In the illustrated exemplary embodiment, the method comprises two main steps.

In a first step S1, energy resources ERs are selected and sorted by characteristics of their links connecting the energy resources ERs with the control center CC. These characteristics can be either measured and/or configured via a user interface.

In a further step S2, the restoration reserve power RRP for the power grid PG is provided by activating sequentially the sorted energy resources ERs of the energy resource pool ERP starting with the selected energy resources ERs having links providing a short reaction time including a short round trip time RTT. In a possible embodiment, the quality of different links connecting the energy resources ERs with the control center CC is continuously monitored by a monitoring unit of the control center CC to predict the round trip times RTTs of each distributed energy resource ER connected to the power grid PG. The energy resources ERs having the shortest calculated round trip times RTTs and/or power activation reaction times POW-RT are most suited for providing a restoration reserve power RRP in an emergency scenario, i.e. in response to an observed deviation at the interconnect IC. These most suited energy resources ERs are selected and kept as a restoration reserve group and activated sequentially starting with the most suited energy resource if a restoration reserve power activation is requested by the grid control center GCC.

The system SYS can comprise a plurality of distributed energy resources ERs of the same or different energy resource type comprising an energy resource controller ERC and a metering device M. The energy resource controller ERC can be connected via possibly unreliable links DL, UL to the control center CC. The energy resources ERs with the strongest and most resilient communication links can be kept at a low power level until the grid control center GCC sends a request signal to provide a restoration reserve power RRP to the control center CC. Starting with the energy resources ERs with the strongest communication links, activation signals are sent in a possible implementation to subsystems or energy resources ERs having progressively weaker links by the control center CC at such times where the control center CC can prove a first required power reaction in time to the grid control center GCC using measurement data transmitted back through the communication links. Further subsystems or energy resources ERs with progressively weaker links can be activated with communication lead times such that all subsequent power reaction proof points are reached in time. An individual activation of energy resources ERs can continue until either the grid control center GCC sends a new signal or the original request is satisfied.

If the grid control center GCC sends a new request command or request signal, the requested change can diminish the original request and the resulting change is propagated first to the energy resource ER comprising the most resilient communication link with the control center CC. In this way, the sum power of the entirety of energy resources ERs is effectively sent by communicating with only few energy resources. If the grid control center GCC sends a new request signal and the requested change reinforces the original request, the activation of the energy resources ERs is continued with faster timings until the new request is satisfied.

In case that the original request has been satisfied, activation of the energy resource ER can be redistributed to first satisfy fast reserve requirements and then other requirements such as battery lifetime requirements in case that the energy resource ER is formed by an energy storing system ESS. The secondary activation can be communicated as a schedule SCH with a fixed activation time and does not require an immediate reaction by the energy resource ER or any specific timing of the respective communication. The schedule SCH can become the basis for any subsequent change in reserve activation.

In a possible implementation, a continuous monitoring of a communication quality for each energy resource ER is performed to predict a corresponding response time. This can be accomplished by a synchronizing clocks across the energy resource pool ERP and by sending communication messages CM from each energy resource of the pool to the pool control center PCC at pre-fixed times, in these messages specifying the time of reception of the last control center message CCM. Since such a communication is necessary anyway for status and measurement communication, no redundancy or any other additional technical complexity is added to the communication system. The control center CC can calculate the communication delays for the downlink DL and uplink UL and can add activation and/or metering delays. The activation or metering delays can be equal for all energy resources ERs of the same energy resource type. The activation and/or metering delays can be determined in a possible implementation in advance and stored in a configuration memory of the control center CC. In a preferred embodiment, the communication quality and communication times can be determined already at the time of the clock synchronization.

With the system SYS according to the present invention, restoration reserve power RRP can be provided by a pool of suitable energy resources ERs that may even have unreliable and low-bandwidth communication links DLs, ULs with the control center CC. The restoration reserve power RRP provided by the suitable energy resources ERs can be used to provide a secondary control power and/or a frequency restoration reserve power and/or even a replacement reserve power for the electrical power grid. The pool of suitable energy resources ERs can provide different kinds of grid stabilizations where a fast reaction to request signals from a higher-level grid control center GCC is required but no immediate activation of the full reserve is necessary. With the system SYS according to the present invention, the bandwidth usage of communication links can be reduced. Consequently, the system SYS can even operate in situations where a communication network is saturated or partially out of service. Due to the distributed structure of the system SYS, the power grid PG becomes even more resilient against different kinds of disturbances. With the system SYS according to the present invention, it is possible that distributed energy resources ERs can participate to provide restoration reserves which are fit to drive back any kind of disturbances of the power supply grid PG. The system SYS according to the present invention provides in a reliable manner a restoration reserve power RRP, in particular because the system SYS is more resilient against any disturbances affecting the communication between the control center CC and the energy resource controller ERC of the different energy resources ERs. For instance, the system SYS is more resilient against any kind of atmospheric or weather-related environmental disturbances. Moreover, the system SYS is more resilient against disturbances caused by external signal sources affecting wireless links between the energy resource controller ERC and the control center CC. In addition, the system SYS can also include in its pool energy resources whose reaction times would make them unsuitable for a given type of reserve duty without the present invention.

Further embodiments of the system SYS are possible. In a possible implementation, the control center CC comprises an interface to perform configurations and/or to input known characteristics of different links ULs, DLs and/or energy resources ERs connected to the control center CC. The selected energy resources ERs kept as a restoration reserve can be indicated to a user in a possible implementation by means of a user interface. Further, sorted energy resources ERs selected as a pool to provide the restoration reserve power RRP can be notified by the control center to the central grid control center GCC. The group of energy resources ERs selected to form a suitable pool of energy resources to provide a contribution to the restoration reserve power RRP can change dynamically depending on the continuously monitored quality of the links connecting the energy resources ERs with the control center CC. For instance, an energy resource ER selected to provide part of the group of energy resources providing the restoration reserve power RRP can be dropped out of the group of suitable energy resources if its communication links ULs, DLs to the control center CC show a reduced current communication quality, in particular a reduced reliability and/or a diminished transmission capacity or bandwidth. This is common for example in weather situations with local thunderstorms, but could also be due to slower-changing environmental factors such as trees sprouting leafs. In such cases, the affected energy resource ER can be substituted by another energy resource comprising communication links with a higher connection quality. An update of the group of energy resources selected to provide a restoration reserve power RRP can be performed in a possible implementation periodically by the control center CC. In an alternative embodiment, the update of a group of energy resources ERs providing the restoration reserve power RRP can be event-driven, for instance if the communication links between the control center CC and an energy resource deteriorates significantly. If a predicted round trip time RTT and/or power reaction time POW-RT of the selected energy resource ER forming part of the group of energy resources providing the restoration reserve power RRP decreases beneath a predetermined or adjustable defined threshold value, the corresponding energy resource ER can be regarded as no longer suitable to make a contribution to the restoration reserve power RRP and be replaced by another more suitable energy resource ER. The thresholds for the admissible round trip time RTTs and/or admissible power reaction time POW-RT can be configured according to system requirements.

In a possible implementation, the different characteristics of the links evaluated by a processing unit of the control center CC can be stored in a local memory of the control center CC. In a specific implementation, the processing unit of the control center CC can evaluate different characteristics and/or parameters of the links according to a configurable evaluation formula. Depending on the system requirements, the evaluation formula can be configured via a configuration interface. In a possible implementation, different characteristics can be given different weights by configuring weighting factors via a configuration interface of the control center CC. The evaluation can in a possible implementation take also other factors into account. In a possible implementation, the reliability and/or resilience of components of the different energy resources ERs can influence the decision which energy resources ERs form part of the restoration reserve power pool. In a possible implementation, only trusted energy resources ERs can form part of the group of selected energy resources ERs used for providing the restoration reserve power RRP for the power grid PG.

1. A system for providing a reserve power for a power grid comprising distributed energy resources controlled by at least one control center via control downlinks and adapted to communicate with said control center via communication uplinks,
wherein at least one control center is configured to sort the energy resources by characteristics of the links and to provide a reserve power to the power grid by activating sequentially the sorted energy resources starting with energy resources having links providing a short reaction time.

2. The system according to claim 1,
wherein the control center is adapted to control the energy resources by transmitting control center messages via the control downlinks connecting the control center with the distributed energy resources and
wherein each distributed energy resource comprises an energy resource controller adapted to receive control center messages and to transmit communication messages via the respective communication uplink to the control center.

3. The system according to claim 1,
wherein said control center is configured to perform a continuous monitoring of a quality of the links connecting the energy resources with the control center to predict a round trip time of each distributed energy resource of said power grid.

4. The system according to claim 2,
wherein each communication message transmitted by the energy resource controller of an energy resource to the control center specifies the time of reception of the last control center message via the control downlink by the respective energy resource controller.

5. The system according to claim 2,
wherein the energy resource controllers of the energy resources and the control center are synchronized to each other by means of high precision clock signals.

6. The system according to claim 2,
wherein a communication message transmitted by an energy resource controller of an energy resource via the communication uplink to the control center is adapted to transport status data and/or measurement data of the respective energy resource,
wherein the measurement data transported in the communication message is generated by a metering device of the respective energy resource.

7. The system according to claim 2,
wherein the control center is adapted to calculate a downlink communication delay across the control downlink and/or an uplink communication delay across the communication uplink on the basis of the control center messages and the communication messages exchanged between the control center and the energy resource controller of the energy resource via the control downlink and the communication uplink.

8. The system according to claim 7,
wherein the control center is adapted to predict a power reaction time of an energy resource depending on the calculated communication delays, an activation delay for activating the respective energy resource and on a predetermined metering delay.

9. The system according to claim 1,
wherein at least one control center is connected via a reliable bidirectional link to a grid control center of the power grid.

10. The system according to claim 9,
wherein the sorted energy resources having links with a short round trip time and/or power reaction time are kept as a group of restoration reserve resources and run at a predetermined power level until the grid control center of the power grid sends an activation control signal via the bidirectional link to the control center requesting to provide a restoration reserve power for the power grid.

11. The system according to claim 10,
wherein the grid control center is connected to at least one grid interconnect of said power grid.

12. The system according to claim 1,
wherein a pool of energy resources including a number of energy resources comprises an associated pool control center adapted to control the energy resources of said energy resource pool via control downlinks.

13. The system according to claim 1,
wherein the distributed energy resources comprise energy storage systems, energy generators and energy consumers.

14. A method for providing a reserve power for a power grid comprising distributed energy resources each being controlled by a control center via a control downlink and being adapted to communicate with said control center via a communication uplink,
the method comprising the steps of:
(a) sorting the energy resources by characteristics of their links with the control center; and
(b) providing the reserve power for the power grid by activating sequentially the sorted energy resources starting with the energy resources having the links providing a short reaction time.

15. The method according to claim 14,
wherein a quality of the links connecting the energy resources with the control center is continuously monitored to predict a round trip time of each distributed energy resource of said power grid.
